(19) United States
(12) Patent Application Publication
(10) Pub. No.: US 2006/0167845 A1
(43) Pub. Date: Jul. 27, 2006

(54) Selection of optimal plans for FIRST-N-ROW queries

(75) Inventors: Li Xia, San Jose, CA (US); You-Chin Fuh, San Jose, CA (US); Yoichi Tsuji, San Jose, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: INTERNATIONAL BUSINESS MACHINES CORPORATION

(21) Appl. No.: 11/042,525

(22) Filed: Jan. 25, 2005

(51) Int. Cl. G06F 17/30

(52) U.S. Cl. 707/3

(57) ABSTRACT

A method, apparatus, and article of manufacture for optimizing a query in a computer system, wherein the query is performed by the computer system to retrieve data from a database stored on the computer system. The optimization comprises determining an optimal access plan for a first-N-rows query by evaluating a cost of fetching N rows, relative to a total number of rows R in a final results set. Specifically, for a pipelined access plan, this comprises calculating how many rows need to be fetched from each table in the pipelined plan in order to obtain the first N rows from the final results set.

### BACKGROUND OF THE INVENTION

1. Field of the Invention

This invention relates in general to database management systems performed by computers, and in particular, to the selection of optimal plans for FIRST-N-ROWS queries.

2. Description of Related Art

Computer systems incorporating Relational DataBase Management System (RDBMS) software using Structured Query Language (SQL) interface are well known in the art. The SQL interface has evolved into a standard language for RDBMS software and has been adopted as such by both the American National Standards Institute (ANSI) and the International Standards Organization (ISO).

For most RDBMS software, FIRST-N-ROW queries are queries for which the time to fetch the first N rows is of more interest than the time to complete the entire query. Such queries can be found in many web-based applications where search results are presented to users one page at a time, and the result shown in the next page is needed only if users choose to move on after browsing the results shown in the current page. Therefore, optimization for fetching the first N rows has been a critical requirement for RDBMS software. This results in the SQL extension which allows application developers to specify such intent through an OPTIMIZE FOR N ROWS clause.

A query with the OPTIMIZE FOR N ROWS clause requires special optimization techniques to return the first (and subsequent) N rows quickly, in contrast to normal query optimization that is applied to make the entire query run fast, especially when the number of rows in the results set is much larger than N. It is known that, for such a query with relatively small N compared with the entire result, a so-called pipelined plan works well in general, wherein the pipelined plan does not involve materialization of intermediate results sets.

Existing solutions include one approach taken by such RDBMS software as DB2 UDB for z/OS, which is offered by IBM CORPORATION, the assignee of the present invention. In this approach, for FIRST-N-ROW queries, the optimizer only keeps one pipelined plan with the minimum cost at each costing stage when a new inner table is added to the join sequence. The cost of the resulting pipelined plan is discounted by a factor of MIN(1, N/estimated_rows_returned) before comparing with the other plans.

Another approach is taken by such RDBMS software as DB2 UDB for LUW, which is also offered by IBM CORPORATION, the assignee of the present invention. In this approach, in addition to the total query cost, the optimizer estimates the cost of fetching the first qualified row on each table in the join sequence of a pipelined plan by considering the cost to fetch the unqualified rows before the first qualified row is encountered. Note that this method has an advantage over the one implemented by DB2 for z/OS in that the two or more competing pipelined plans can be differentiated by evaluating the efficiency of retrieving the first qualified row on every table. Preference is given to a pipelined plan over a non-pipelined plan through the cost competition.

However, these two approaches for OPTIMIZE FOR N ROWS do have problems.

One problem is an incorrect method of discounting the cost of the pipelined plan, because it assumes that N rows are fetched on every table in the join sequence in order to return the first N rows from the final results set, which is not true in general. As a result, the cost comparison between the pipelined plan and other non-pipelined plans tends to be inaccurate.

Another problem is that, in order to fetch N final result rows, extra rows may be fetched on each table (rows that will be unqualified by predicates evaluated after a row is fetched or by the filtering of subsequent joins). The cost of fetching unnecessary rows on each table is not reflected in the cost evaluation accurately, since such a factor is only considered for the first qualified row.

Thus, there is a need in the art for improved optimization techniques that ensure the selection of optimal (or a near optimal) access plans for queries with the OPTIMIZE FOR N ROWS clause. Specifically, there is a need in the art for solutions to problems directed to the selection of optimal pipelined plans for FIRST-N-ROW queries.

### SUMMARY OF THE INVENTION

To overcome the limitations in the prior art described above, and to overcome other limitations that will become apparent upon reading and understanding the present specification, the present invention discloses a method, apparatus, and article of manufacture for optimizing a query in a computer system, wherein the query is performed by the computer system to retrieve data from a database stored on the computer system. The optimization comprises determining an optimal access plan for a first-N-rows query by evaluating a cost of fetching N rows, relative to a total number of rows R in a final results set. Specifically, for a pipelined access plan, this comprises calculating how many rows need to be fetched from each table in the pipelined plan in order to obtain the first N rows from the final results set.

### BRIEF DESCRIPTION OF THE DRAWINGS

Referring now to the drawings in which like reference numbers represent corresponding parts throughout:

FIG. 1 illustrates an exemplary computer hardware and software environment that could be used with an embodiment of the present invention;

FIG. 2 is a flowchart illustrating the steps necessary for the interpretation and execution of SQL statements in an interactive environment according to an embodiment of the present invention;

FIG. 3 is a flowchart illustrating the steps necessary for the interpretation and execution of SQL statements embedded in source code of a host language according to an embodiment of the present invention; and

FIG. 4 is a flowchart illustrating the logic of the method for query optimization according to the preferred embodiment of the present invention.

### DETAILED DESCRIPTION OF THE PREFERRED EMBODIMENT

In the following description of the preferred embodiment, reference is made to the accompanying drawings, which form a part hereof, and in which is shown by way of illustration a specific embodiment in which the invention may be practiced. It is to be understood that other embodiments may be utilized and structural and functional changes may be made without departing from the scope of the present invention.

### OVERVIEW

The present invention determines an optimal access plan for a FIRST-N-ROWS query by evaluating the cost of fetching N rows, relative to the cost of fetching the total number of rows R in the final results set. The present invention applies a cost reduction to each step of a join sequence cost evaluation for the query, relative to the total number of rows R in the final results set. The cost reduction represents an estimate of the cost of retrieving rows for an intermediate step to return N rows at the end of the join sequence for the query, relative to the cost of retrieving the total number of rows R in the final results.

The following steps are performed in determining the cost reduction:
Given a join sequence, the cost reduction on each table is evaluated most accurately once it is known how many rows need to be fetched from the table in order to return the first N rows from the final results set.
Given a pipelined plan, the number of rows needed to be fetched from each table in order to return the first N rows from the final results set is analyzed by traversing the plan and estimating the cardinality based on the predicates eligible on each table.
The cost reduction on each table can be performed independently of the costing process for the pipelined plan.
After the cost reduction on each table is calculated based on the cardinality estimation, the entire reduced cost of a pipelined plan is evaluated.

The present invention concentrates on how to accurately calculate the cost reduction at each step of the join sequence. With a more accurate cost reduction applied to each step of the pipelined plan evaluation, a much better job can be done to differentiate the efficiencies among different pipelined plans. The best plan is considered to be the one that has the least redundant access to data on the intermediate joins to retrieve the first N rows in the results set.

Hardware and Softwar Environment

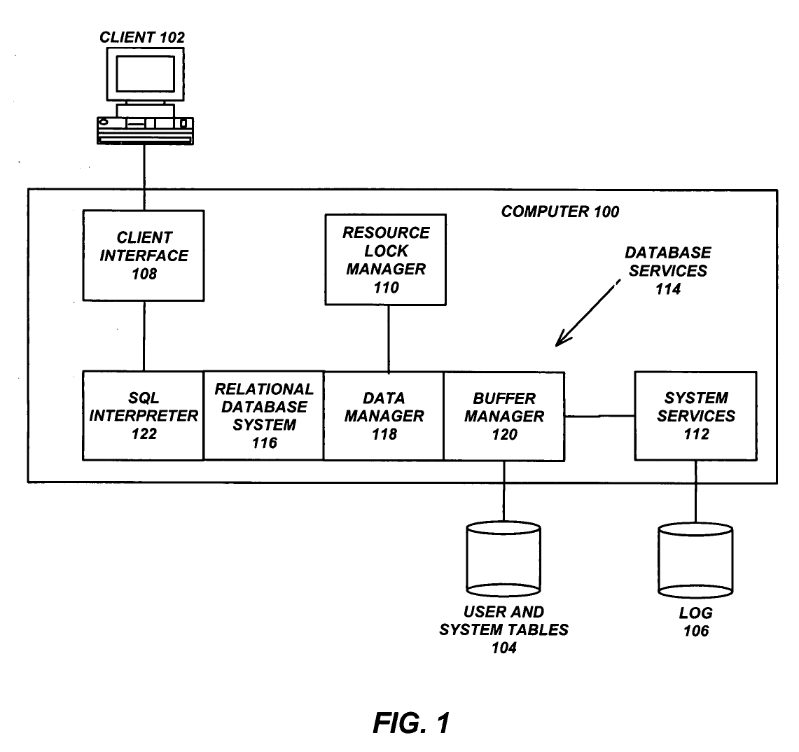

FIG. 1 illustrates an exemplary computer hardware and software environment that could be used with the present invention. In the exemplary environment, a server system 100 is connected to one or more client systems 102, in order to manage one or more databases 104 and 106 shared among the client systems 102.

Operators of the client systems 102 use a standard operator interface 108 to transmit commands to and from the server system 100 that represent commands for performing various search and retrieval functions, termed queries, against the databases. In the present invention, these queries conform to the Structured Query Language (SQL) standard, and invoke functions performed by Relational DataBase Management System (RDBMS) software. In the preferred embodiment of the present invention, the RDBMS software comprises the DB2 product offered by IBM for the MVS, LINUX, UNIX, WINDOWS or OS/2 operating systems. Those skilled in the art will recognize, however, that the present invention has application to any RDBMS software.

As illustrated in FIG. 1, the RDBMS includes three major components: the Resource Lock Manager (RLM) 110, the Systems Services module 112, and the Database Services module 114. The RLM 110 handles locking services, because the RDBMS treats data as a shared resource, thereby allowing any number of users to access the same data simultaneously, and thus concurrency control is required to isolate users and to maintain data integrity. The Systems Services module 112 controls the overall RDBMS execution environment, including managing log data sets 106, gathering statistics, handling startup and shutdown, and providing management support.

At the heart of the RDBMS architecture is the Database Services module 114. The Database Services module 114 contains several submodules, including a Relational Database System (RDS) 116, Data Manager 118, Buffer Manager 120, and SQL Interpreter 122. These submodules support the functions of the SQL language, i.e., definition, access control, retrieval, and update of user and system data.

Generally, each of the components, modules, and submodules of the RDBMS comprises instructions and/or data, and are embodied in or retrievable from a computer-readable device, medium, or carrier, e.g., a memory, a data storage device, a remote device coupled to the server computer 100 by a data communications device, etc. Moreover, these instructions and/or data, when read, executed, and/or interpreted by the server computer 100, cause the server computer 100 to perform the steps necessary to implement and/or use the present invention.

Thus, the present invention may be implemented as a method, apparatus, or article of manufacture using standard programming and/or engineering techniques to produce software, firmware, hardware, or any combination thereof. The term “article of manufacture”, or alternatively, “computer program carrier”, as used herein is intended to encompass a computer program accessible from any computer-readable device, carrier, or media.

Of course, those skilled in the art will recognize many modifications may be made to this configuration without departing from the scope of the present invention. Specifically, those skilled in the art will recognize that any combination of the above components, or any number of different components, including computer programs, peripherals, and other devices, may be used to implement the present invention, so long as similar functions are performed thereby.

### Interactive SQL Execution

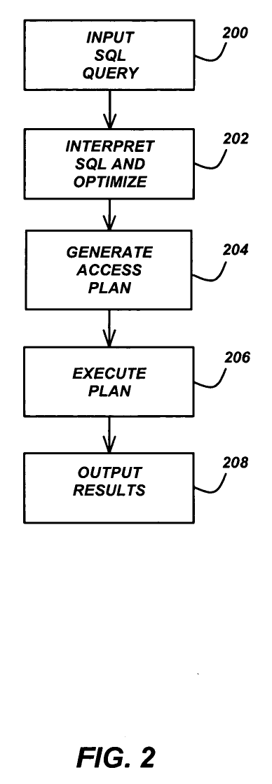

FIG. 2 is a flowchart illustrating the steps necessary for the interpretation and execution of SQL statements in an interactive environment according to the present invention. Block 200 represents the input of SQL statements into the server system 100. Block 202 represents the step of compiling or interpreting the SQL statements. An optimization function within block 202 may transform or optimize the SQL query in a manner described in more detail later in this specification. Generally, the SQL statements received as input specify only the desired data, but not how to retrieve the data. This step considers both the available access paths (indexes, sequential reads, etc.) and system held statistics on the data to be accessed (the size of the table, the number of distinct values in a particular column, etc.), to choose what it considers to be the most efficient access path for the query. Block 204 represents the step of generating a compiled set of runtime structures called an access plan from the compiled SQL statements. Block 206 represents the execution of the access plan and Block 208 represents the output of the results.

### Embedded/Batch SQL Execution

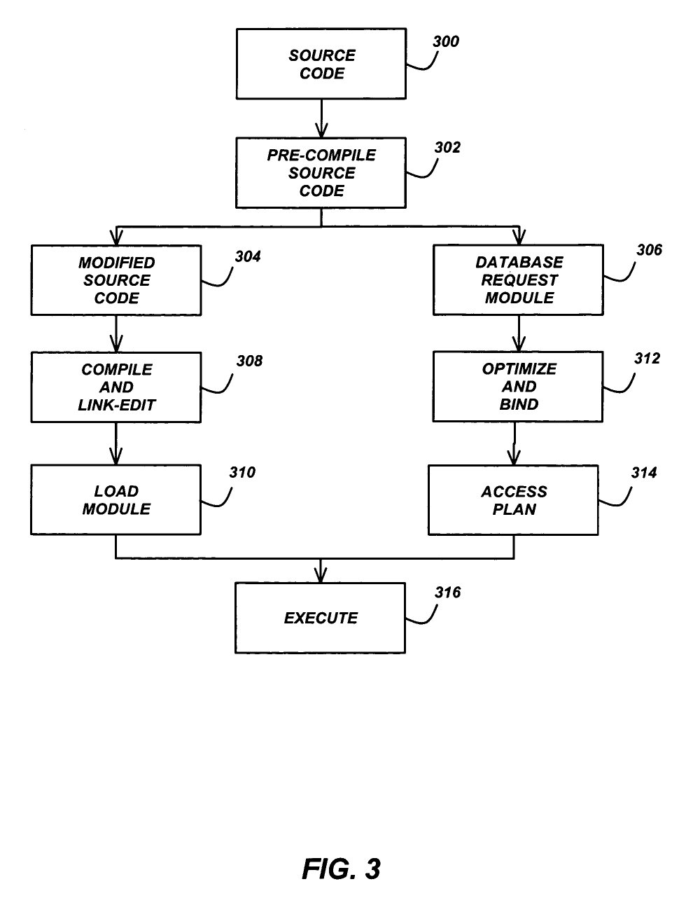

FIG. 3 is a flowchart illustrating the steps necessary for the interpretation and execution of SQL statements embedded in source code according to the present invention. Block 300 represents program source code containing a host language (such as COBOL or C) and embedded SQL statements. The program source code is then input to a pre-compile step 302. There are two outputs from the pre-compile step 302: a modified source module 304 and a Database Request Module (DBRM) 306. The modified source module 304 contains host language calls to the RDBMS, which the pre-compile step 302 inserts in place of SQL statements. The DBRM 306 is comprised of the SQL statements from the program source code 300. A compile and link-edit step 308 uses the modified source module 304 to produce a load module 310, while an optimize and bind step 312 uses the DBRM 306 to produce a compiled set of runtime structures for the access plan 314. As indicated above in conjunction with FIG. 2, the SQL statements from the program source code 300 specify only the desired data, but not how to retrieve the data. The optimize and bind step 312 may optimize the SQL query in a manner described in more detail later in this specification. Thereafter, the optimize and bind step 312 considers both the available access paths (indexes, sequential reads, etc.) and system held statistics on the data to be accessed (the size of the table, the number of distinct values in a particular column, etc.), to choose what it considers to be the most efficient access path for the query. The load module 310 and access plan 314 are then executed together at step 316.

### Description of the Optimization Technique

The present invention discloses an improved optimization technique that is typically performed at step 202 of FIG. 2 or step 312 of FIG. 3. Specifically, the present invention discloses a method for selection of optimal access plans for queries having an OPTIMIZE FOR N ROWS clause.

The optimization performed at step 202 of FIG. 2 or step 312 of FIG. 3 comprises determining an optimal access plan for a FIRST-N-ROWS query by evaluating the reduced cost of fetching N rows, relative to the total number of rows R in the final result set, by calculating how many rows need to be fetched from each table in the query in order to obtain the first N rows from the final results set.

The main goal of the present invention is to efficiently model the cost reduction resulting from only part of the query processing, i.e., only that which is needed to return the first N rows. The present invention efficiently characterizes how many rows need to be fetched from each table in a pipelined plan in order to return the first N rows from the final results set. Each table in the pipeline plan is characterized separately, as well as based on its join relations with other tables, and the process is iterative starting from the last table in a join sequence of the query. The cost reduction for the pipelined plan as a whole is proportional to an accumulated value resulting from this characterization divided by an estimate of the total number of rows R in the final results set.

A definition of terminology is provided below:
ff: The inefficient filtering that is not covered by the index access (table space scan) of a table. Therefore, to return m qualified rows, m/ff rows need to be fetched.
estimated_rows_returned: The optimizer's estimate of the number of rows in the final results set of the query.
estimate_fetch_row: The optimizer's estimate of how many rows need to be fetched from a table.
estimate_qualified_fetch_row: The optimizer's estimate of how many qualified rows need to be fetched from a table.
rows_per_outer_probe: Currently, most optimizers calculate a value to indicate, on average for each join column set between one or more outer tables and an inner table, how many rows will survive all the predicates' evaluation and be returned as the qualified rows from the inner table.

When processing each table in the join sequence, the present invention calculates the following factors:
How many qualified rows need to be fetched from a current table in order to satisfy the FIRST-N-ROW query? This value is denoted by current_qualified_fetch_row. For each table, the number of qualified rows to be fetched is the number of rows to be fetched and propagated to join subsequent tables after surviving all the predicates' evaluations on the table. It is known that the number for the last table in the join sequence is N.
How many rows need to be fetched from a current table in order to satisfy tables joined subsequently? This value is denoted by current_total_fetch_row. It will include current_qualified_fetch_row value as well as the number of rows fetched without being able to survive the predicates' evaluation on the table.
How many probes into a current table need to be initiated from a previous table? It will be equivalent to the number of qualified rows need to be fetched from outer composite tables. This value is denoted by previous_qualified_fetch_row. The value should be determined by how a table is joined with previous tables and subsequent tables.

Through processing each table in a pipelined plan, the following two factors are accumulated.
How many tables do not need to finish the whole table processing to satisfy the FIRST-N-ROW query? Such tables are categorized into a special group known as C, and the count of such tables is denoted as E.
How many rows are fetched in total by all the tables in group C? The value is the sum of current_total_fetch_row from all the tables in group C. The value is denoted as total_fetch_row.

The above iterative process will stop once it finishes processing all the tables in the pipelined plan or once it encounters the first table that does not belong to group C. After the processing is finished, on average, the number of rows that need to be fetched from each table in a pipelined plan is:
total_fetch_row/E
which is denoted as average_fetch_row. The cost reduction is proportional to:
average_fetch_row/estimated_rows_returned

The present invention does not make any assumptions of how many qualified or non-qualified rows need to be fetched from each table, which is a common practice for most RDBMS software. Instead, the value is calculated for each table in a pipelined plan based on how the table is joined with previous and subsequent tables in the plan. Therefore, the present invention provides the most accurate cost reduction so far to simulate the savings in the processing due to returning only part of the final results set.

The present invention has a number of distinct advantages over the other approaches described above. Specifically, the present invention introduces a new mechanism to model the cost reduction on pipelined plans more properly. In this regard, for each table joined in a pipelined plan, the number of qualified rows that need to be fetched from the table is calculated according to how subsequent tables are accessed in the plan and how the table is joined with previous tables.

Consider the inefficiency of the index access (table space scan) on a table for all the qualified rows instead of the just the first qualified row. When there are filtering that is not covered by the index access (table space scan) of a table, on average, before returning each qualified row, some non-qualified rows will need to be fetched.

Cost Reduction Logic

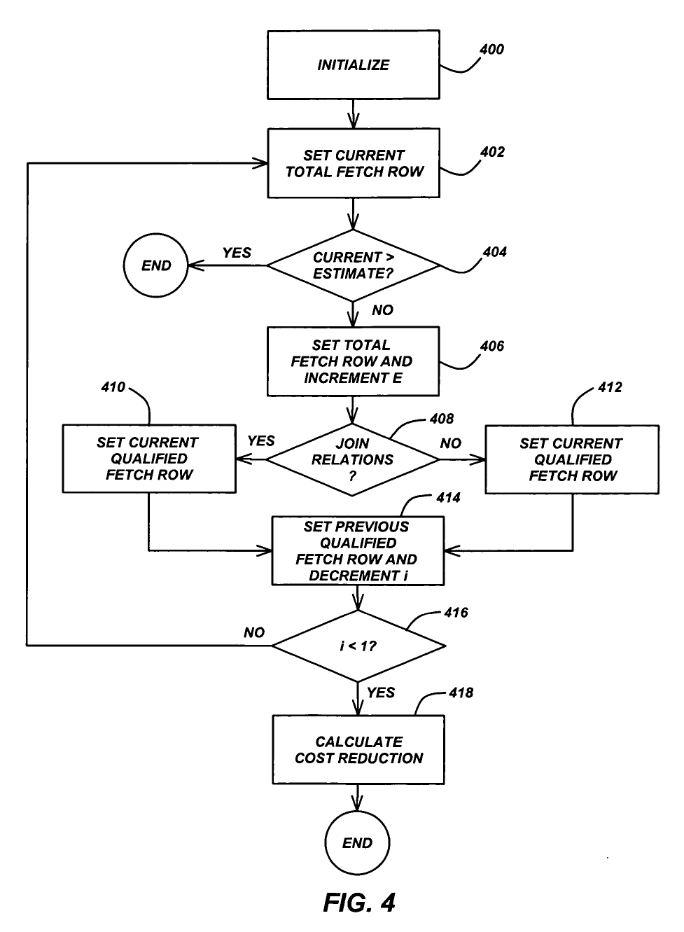

FIG. 4 is a flow chart that illustrates the cost reduction logic described above. In this example, the cost reduction logic is performed on a pipelined plane comprised of a K table join, wherein i is the ith table in the join sequence.

Block 400 represents the initialization of the logic. This Block first determines whether the estimated number of rows for the whole result set (denoted by estimated-rows-returned) is smaller than N, in which case the logic terminates; otherwise, the value of i is set to K, the value of current_qualifed_fetch_rowᵢ is set to N for the last table in the join sequence, the value of E is set to 0, and the value of total_fetch_row is set to 0.

Block 402 represents the following calculation being made:
current_total_fetch_rowᵢ=current_qualifed_fetch_rowᵢ/ffᵢ

Block 404 is a decision block that determines whether current_total_fetch_rowᵢ is larger than the estimate_fetch_rowᵢ from the ith table. If so, the logic ends; otherwise, control transfers to Block 406.

Block 406 represents the following calculations being made:
total_fetch_row=total_fetch_row+current_total_fetch_rowᵢ E=E+1

Block 408 is a decision block that determines whether the ith table has join relations with previously joined tables. If so, control transfers to Block 410; otherwise, control transfers to Block 412.

Block 410 represents the following calculation being made:
current_qualifed_fetch_rowᵢ₋₁=current_qualifed_fetch_rowᵢ/rows_per_outer_probeᵢ
If the ith table has join relations with previously joined tables, on average, for each probing of the inner table initiated from outer composite tables, the number of rows that survive all the predicates evaluation is rows_per_outer_probe. Note that current_qualifed_fetch_rowᵢ is used here instead of current_total_fetch_rowi because non-efficient filtering has already been incorporated into the rows_per_outer_probe calculation.

Block 412 represents the following calculation being made:
current_qualifed_fetch_rowᵢ₋₁=current_qualified_fetch_rowᵢ₋₁
Note that this scenario, where the ith table does not have join relations with previously joined tables, is a Cartesian join between the ith table and the outer composite tables, which should happen only for leading tables in ajoin sequence. In this case, the number of qualified rows to be fetched is the same for the ith table and the outer composite tables because they perform the same role in terms of how the subsequent tables are joined.

Block 414 represents the following calculations being made:
previous_qualified_fetch_row=current_qualifed_fetch_rowᵢ₋₁ i=i−1

Block 416 is a decision block that determines whether i<1. If so, the evaluation of current_qualifed_fetch_rowᵢ for all the tables in the join sequence is completed and control transfers to Block 318; otherwise, control transfers to Block 402.

Upon completion of the evaluation, at Block 418, the average number of rows to be fetched from each table in the pipelined plan is calculated as:
total_fetch_row/E
Therefore, the cost reduction to be applied is proportional to:
(total_fetch_row/E)/estimated_rows_returned.
Thereafter, the logic terminates.

### EXAMPLE QUERIES

To illustrate the advantages of the cost reduction model proposed by the present invention, the following example is provided.

```
SELECT *
FROM T1, T2
WHERE T1.C1 = T2.C1 (P1)AND
      T1.C2 = ? (P2) AND <----------- 2% selectivity
      FOR FETCH ONLY
      OPTIMIZE FOR 48 ROWS
      FETCH FIRST 48 ROWS ONLY;
```

In the above query, the FOR FETCH ONLY clause ensures that the result table is read-only, the OPTIMIZE FOR 48 ROWS clause indicates the intent to retrieve only a subset of the result or to give priority to the retrieval of the first few rows, and the FETCH FIRST 48 ROWS ONLY clause sets the maximum number of rows that can be retrieved from within the SELECT statement.

In this example, assume the following: (1) both T1 and T2 have 400,000 rows; (2) with predicate P2, there will be 8,000 rows remaining in T1; (3) both columns of T1.C1 and T2.C1 have 200,000 distinct values; (4) the total final result size is 16,000 rows; and (5) there are 3 indexes on table T1 and T2, as indicated below:

| | |
|---|---|
| INX1_T1(T1.C1) | <----------- Cluster ratio is 95% |
| INX2_T1(T1.C2) | <----------- Cluster ratio is 95% |
| INX1_T2(T2.C1) | <----------- Cluster ratio is 100% |

In illustrating how to apply the cost reductions, consider the following two pipelined plans:

1. T1 (using INX1_T1) nest loop join T2 (using INX1_T2)

2. T1 ( using INX2_T1) nest loop join T2 (using INX1_T2)

Assume that without any cost reduction, the two plans have relatively the same costs.

With the approach described above used by DB2 UDB for z/OS, only one pipelined plan will be kept until the final stage. For each table in the final surviving pipelined plan, it assumes 48 rows need to be fetched in order to return the first 48 rows from final results set. Therefore, no matter which pipelined plan is kept until the final cost reduction stage, it will apply the same cost reduction as the following.
(48 rows fetched from T1)+(48 rows fetched from T2)→(48 rows returned from RESULTS SET)

Because 48 rows will be fetched from each table and 16000 rows will be produced by the query, the cost reduction will be proportional to 48/16000.

With the approach described above used by DB2 UDB for LUW, the two pipelined plans will be distinguished according to the different efficiencies to access table T1, because the access sub-plans on T2 are the same between the two pipelined plans.

According to the definition of ff, by using index INX1_T1 in plan (1), ff is 2% because the evaluation of predicate P2 cannot be covered by the index plan. Therefore, for T1 in plan (1), (48+1/ff−1) (which is 97) rows need to be fetched in order to retrieve the first 48 rows. By using index INX2_T1 in plan (2), ff=100% because the evaluation of predicate P2 is covered by the index. Therefore, for T1 in plan (2), 48 rows need to be fetched in order to retrieve the first 48 rows. With index INX1_T2 to access T2 in both plans, ff is 100% because there are no predicates that are not covered by INX1_T2. Therefore, for T2 in both plans, 48 rows need to be fetched.

So, for plan (1), this approach will apply the cost reductions as the following.
(97 rows fetched from T1)+(48 rows fetched from T2)→(48 rows returned from RESULTS SET)

For plan (2), this approach will apply the cost reductions as the following.
(48 rows fetched from T1)+(48 rows fetched from T2)→(48 rows returned from RESULTS SET)

With plan (2), a cost reduction that is proportional to 48/16000 will be applied on T1 and T2, respectively. With plan (1), a cost reduction that is proportional to 97/16000 will be applied on T1 and a cost reduction that is proportional to 48/16000 will be applied on T2. Therefore, plan (2) will get more cost reduction. Since plan (1) and plan (2) have relatively the same cost without any reduction, plan (2) will be picked over plan (1) as the optimal pipelined plan. Plan (2) will then compete with other non-pipelined plans based on the costs.

From the above example, the approach used by DB2 UDB for LUW provides a better mechanism over the approach used by DB2 UDB for z/OS for distinguishing between the two pipelined plans according to their ability to return the first qualified rows. However, the approach used by DB2 UDB for LUW has the problem that it always assumes that 48 qualified rows need to be fetched. Another problem is that the approach used by DB2 UDB for LUW only considers the cost to fetch (1/ff−1) non-qualified rows before finding the first qualified row.

With the approach introduced by the present invention, when T2 is joined to T1 on column T2.C1, for each distinct T2.C1 value, two rows will be returned on average. Therefore, in order to return 48 rows after joining T2, only 24 matching values need to be found between T1.C1 and T2.C1. Accordingly, assuming each T1.C1 could find a matching T2.C1, only 24 qualified rows are needed after accessing T1.

In addition, once it has determined that 24 qualified rows are needed from table T1, according to the different efficiencies to access T1 between plan (1) and plan (2), plan (1) needs to fetch 24/ff (which is 1200) rows from T1. Plan (2) needs to fetch 24/ff (which is 24) rows from T1.

Therefore, with the new cost reduction model of the present invention, a more reasonable and realistic cost reduction is as follows.

For plan (1), the present invention will apply the cost reductions as follows:
(1200 rows fetched from T1)+(48 rows fetched from T2)→(48 rows returned from RESULTS SET)

For plan (2), the present invention will apply the cost reductions as follows:
(24 rows fetched from T1)+(48 rows fetched from T2)→(48 rows returned from RESULTS SET)

With the approach of the present invention, the cost reduction will be proportional to the average rows fetched from each table. With plan (1), on average, 624 rows will be fetched from each table. With plan (2), on average, 36 rows will be fetched from each table. Therefore, plan (1) will have a cost reduction proportional to 624/16000 and plan (2) will have a cost reduction proportional to 36/16000. Therefore, plan (2) will be picked over plan (1).

### CONCLUSION

This concludes the description of the preferred embodiment of the invention. The following describes some alternative embodiments for accomplishing the present invention. For example, any type of computer, such as a mainframe, minicomputer, or personal computer, could be used with the present invention. In addition, any software program performing database queries could benefit from the present invention.

In summary, the present invention discloses a method, apparatus, and article of manufacture for optimizing a query in a computer system, wherein the query is performed by the computer system to retrieve data from a database stored on the computer system. The optimization comprises determining an optimal access plan for a first-N-rows query by evaluating a cost of fetching N rows, relative to a total number of rows R in a final results set. Specifically, for a pipelined access plan, this comprises calculating how many rows need to be fetched from each table in the pipelined plan in order to obtain the first N rows from the final results set.

The foregoing description of the preferred embodiment of the invention has been presented for the purposes of illustration and description. It is not intended to be exhaustive or to limit the invention to the precise form disclosed. Many modifications and variations are possible in light of the above teaching.

What is claimed is:

1. A method of optimizing a query in a computer system, the query being performed by the computer system to retrieve data from a database stored on the computer system, the method comprising:
(a) determining an optimal access plan for a first-N-rows query by evaluating a cost of fetching N rows, relative to a total number of rows R in a final results set.

2. The method of claim 1, wherein the access plan is a pipelined plan.

3. The method of claim 2, wherein the determining step comprises calculating how many rows need to be fetched from each table in the pipelined plan in order to obtain the first N rows from the final results set.

4. The method of claim 3, wherein the calculating step comprises evaluating cardinality based on the predicates eligible on the table.

5. The method of claim 3, wherein the calculating step comprises determining how many qualified rows need to be fetched from a current table in order to satisfy the first-N-rows query.

6. The method of claim 3, wherein the calculating step comprises determining how many rows need to be fetched from a current table in order to satisfy tables joined subsequently.

7. The method of claim 3, wherein the calculating step comprises determining how many probes into a current table need to be initiated from a previous table.

8. The method of claim 3, wherein the calculating step comprises, for each table joined in a pipelined plan, calculating the number of qualified rows that need to be fetched from a current table according to how subsequent tables are accessed in the plan and how the current table is joined with previous tables.

9. A computer-implemented apparatus for optimizing a query, the query being performed to retrieve data from a database, comprising:
(a) a computer system having a data storage device coupled thereto, the data storage device storing the database; and
(b) logic, performed by the computer system, for determining an optimal access plan for a first-N-rows query by evaluating a cost of fetching N rows, relative to a total number of rows R in a final results set.

10. The apparatus of claim 9, wherein the access plan is a pipelined plan.

11. The apparatus of claim 10, wherein the logic for determining comprises logic for calculating how many rows need to be fetched from each table in the pipelined plan in order to obtain the first N rows from the final results set.

12. The apparatus of claim 11, wherein the logic for calculating comprises logic for evaluating cardinality based on the predicates eligible on the table.

13. The apparatus of claim 11, wherein the logic for calculating comprises logic for determining how many qualified rows need to be fetched from a current table in order to satisfy the first-N-rows query.

14. The apparatus of claim 11, wherein the logic for calculating comprises logic for determining how many rows need to be fetched from a current table in order to satisfy tables joined subsequently.

15. The apparatus of claim 11, wherein the logic for calculating comprises logic for determining how many probes into a current table need to be initiated from a previous table.

16. The apparatus of claim 11, wherein the logic for calculating comprises, for each table joined in a pipelined plan, logic for calculating the number of qualified rows that need to be fetched from a current table according to how subsequent tables are accessed in the plan and how the current table is joined with previous tables.

17. An article of manufacture embodying logic for performing a method for optimizing a query, the query being performed by a computer system to retrieve data from a database stored in a data storage device coupled to the computer system, the method comprising:
(a) determining an optimal access plan for a first-N-rows query by evaluating a cost of fetching N rows, relative to a total number of rows R in a final results set.

18. The article of claim 17, wherein the access plan is a pipelined plan.

19. The article of claim 18, wherein the determining step comprises calculating how many rows need to be fetched from each table in the pipelined plan in order to obtain the first N rows from the final results set.

20. The article of claim 19, wherein the calculating step comprises evaluating cardinality based on the predicates eligible on the table.

21. The article of claim 19, wherein the calculating step comprises determining how many qualified rows need to be fetched from a current table in order to satisfy the first-N-rows query.

22. The article of claim 19, wherein the calculating step comprises determining how many rows need to be fetched from a current table in order to satisfy tables joined subsequently.

23. The article of claim 19, wherein the calculating step comprises determining how many probes into a current table need to be initiated from a previous table.

24. The article of claim 19, wherein the calculating step comprises, for each table joined in a pipelined plan, calculating the number of qualified rows that need to be fetched from a current table according to how subsequent tables are accessed in the plan and how the current table is joined with previous tables.
